(19) United States
(12) Patent Application Publication
(10) Pub. No.: US 2015/0218815 A1
(43) Pub. Date: Aug. 6, 2015

(54) CORROSION RESISTANT STRUCTURAL REINFORCEMENT MEMBER

(71) Applicant: MORTAR NET USA, LTD., BURNS HARBOR, IN (US)

(72) Inventor: Gary R. Johnson, Gary, IN (US)

(21) Appl. No.: 14/610,075

(22) Filed: Jan. 30, 2015

Related U.S. Application Data
(60) Provisional application No. 61/934,504, filed on Jan. 31, 2014.

(51) Int. Cl. E04C 5/01; B05D 1/36; B05D 7/14; E04C 5/04

(52) U.S. Cl. CPC E04C 5/015; E04C 5/04; B05D 1/36; B05D 7/148

(57) ABSTRACT

A corrosion resistant structural reinforcing member for use in a construction material is disclosed. The structural reinforcing member has a metal alloy core, a galvanic protection layer coating the metal alloy core, and at least one chemically corrosive-resistant barrier coating the galvanic protection layer. The galvanic protection layer is positioned between the metal alloy core and the chemically corrosive-resistant barrier.

### CROSS REFERENCE TO RELATED APPLICATIONS

The present application is a non-provisional of U.S. application Ser. No. 61/934,504, filed on Jan. 31, 2014, the entire content of which is hereby incorporated by reference in its entirety.

### FIELD

The application relates to steel structural members for use industrial construction and, in particular, to corrosion resistant systems for use in conjunction with steel structural members.

BACKGROUND

Steel wire products, such as concrete rebar, and other steel structural elements, for example, steel mesh or lattice, are frequently used in reinforced concrete and reinforced masonry structures, to strengthen and hold the concrete in compression. Frequently these steel reinforcing members are subject to corrosive conditions, such as those resulting from deicing salts applied to roadways or marine conditions, among others.

Galvanizing is a well-known treatment process to protect steel reinforcing members from corrosion when embedded in a cement medium. Galvanization is the process of coating steel or iron with zinc. The zinc preferentially reacts to the conditions causing corrosion (such as in the presence of an electrolyte) and thereby serves as a sacrifice to protect the steel from corroding instead. In particular, the zinc serves as a galvanic anode protecting the steel, known as cathodic protection. Cathodic, or galvanized, protection provides significant corrosion resistance, particularly given that even if the coating is scratched, abraded, or cut, thereby exposing the steel to the air and moisture, the exposed steel will still be protected from corrosion due to the galvanic action of the zinc in contact with the steel—an advantage absent from paint, enamel, powder coating and other methods. As such, galvanizing provides a relatively long maintenance-free service life, even in the event that portions of the coating are damaged.

Galvanization of a steel or iron product can be achieved in a number of ways, and the method of application is typically determined by the product to which it will be applied. Mill galvanizing applies a relatively thin coating during the steel product manufacturing process. In comparison, hot dipped galvanizing is performed by submerging a previously fabricated steel member or fabricated assembly, into a bath of molten zinc typically at a temperature of 860 degrees Fahrenheit. Hot-dip galvanizing deposits a thick layer to the metal.

Hot-dip galvanizing is frequently used to prevent corrosion of steel wire products. However, certain disadvantages accompany the process. For example, molten zinc can present hazardous working conditions from the zinc vapor rising into the air. Metal fume fever, also known as zinc shakes or galvie flu, is an illness caused primarily by exposure to fumes from chemicals such as zinc oxide (ZnO). Similar emissions may be dispersed into the environment, leading to a particularly environmentally unfriendly manufacturing process and stringent regulations of that process. Such regulations have led to fewer sources of hot-dip galvanization and higher costs.

After the steel wire has been hot-dipped, the resulting galvanized steel has additional disadvantages. For example, hot-dipping can create sharp dendrites—tree-like structures of crystals that grow when the molten metal cools—that can cut the hands of workers who are installing the products. Additionally, hot-dipped galvanized steel products also tend to stick together after the galvanization process, requiring additional labor to separate the reinforcing members prior to installation.

Another means of protecting steel reinforcing members is to create a chemically-resistant mechanical barrier coating on the steel member, thereby isolating the steel from the outside elements. For example, epoxy coatings are commonly used to coat rebar used in concrete pavements.

However, epoxy or other mechanical barrier coatings do not offer the same level of protection that galvanization does. Because the coating merely isolates the steel from the air, moisture and other outside elements, corrosion will arise where any defects in the coating are present. Thus, substantial care must be taken prior to and during installation (including inspecting and repairing any defects in the coating), as any damage to the coating will reduce the corrosion resistance of the steel member.

Accordingly, there has been a need for an improved corrosion resistance system applicable to steel reinforcing members which offers the corrosion resistance of galvanization, is safe and easy to apply, eliminates hazardous emissions and provides installers easy handling during field installation.

### SUMMARY

The present application discloses a corrosion resistant structural reinforcing member. The structural reinforcing member includes a metal alloy core, a galvanized protection layer coating the metal alloy core, and at least one chemically corrosive-resistant barrier coating the galvanic protection layer, with the galvanic protection layer being positioned between the metal alloy core and the chemically corrosive-resistant barrier.

Also disclosed in a method for resisting corrosion of structural reinforcing members for use in a construction material. The method includes coating a metal alloy core with a galvanic protectant and applying an epoxy to the surface of the metal alloy core and galvanic protectant combination.

### BRIEF DESCRIPTION OF THE FIGURES

FIG. 1 is a perspective view of a reinforcing member in accordance with an embodiment of the present application.

FIG. 2 is a cross-sectional view of the reinforcing member depicted in FIG. 1, taken along line 2-2.

FIG. 3 is a perspective view of a lattice of reinforcing members in accordance with an embodiment of the present application.

FIG. 4 is a perspective view of the lattice structure of FIG. 3 embedded in a construction material.

FIG. 5 is a perspective view of an alternate embodiment of the present application.

### DETAILED DESCRIPTION

In one embodiment, the present application discloses a corrosion resistant structural reinforcing member for use in a construction material or industrial structures, such as masonry walls, bridges, pavement or marine structures. The reinforcing member includes a layer of galvanic protection overlaid with an additional layer of chemically corrosive-resistant material, such as epoxy, creating a coating over the reinforcing member that mechanically isolates the galvanized layer from air, water or other atmospheric conditions.

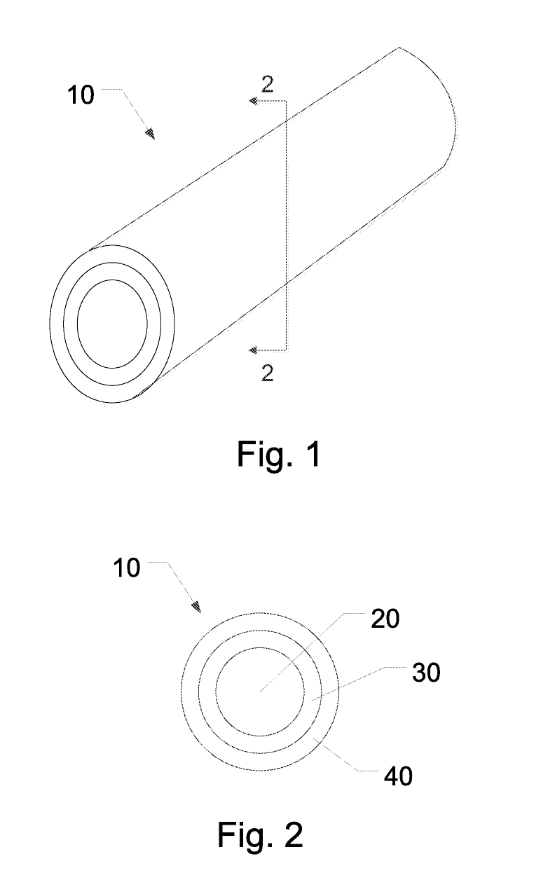

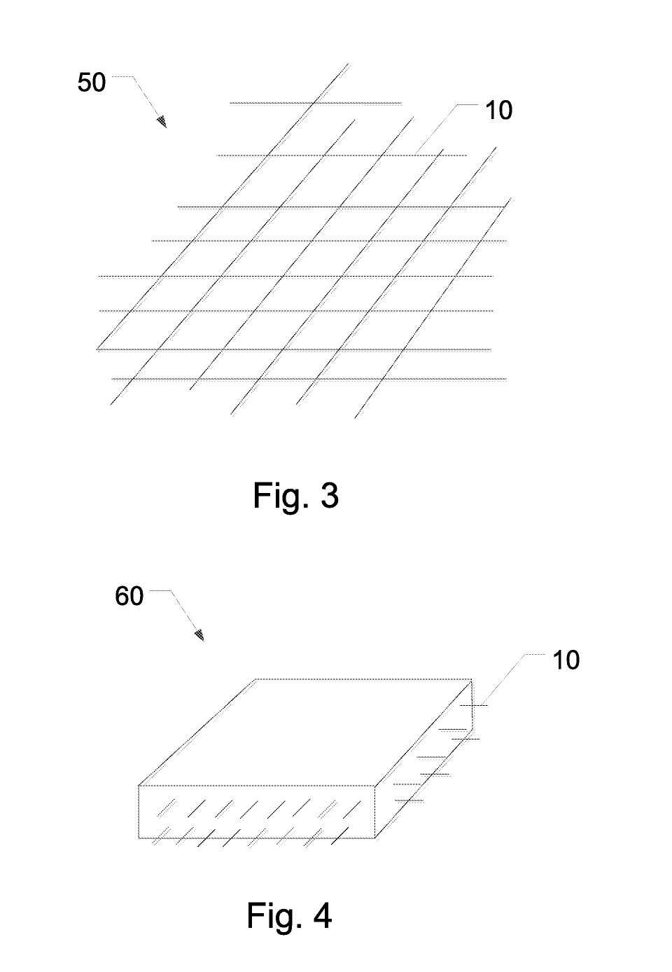

As shown in FIGS. 1 and 2, the reinforcing member 10 may, though not necessarily, be formed into an elongated wire or rod shaped structure. Although depicted in a cylindrical configuration, the reinforcing member 10 may be manufactured to multiple different configurations, such as a rectangular or triangular prism. Further, as shown, multiple reinforcing members 10 may be combined to form a ladder or lattice structure 50, as depicted in FIG. 3. Any number of reinforcing members may be combined in any number of configurations.

As shown in FIG. 2, the reinforcing member 10 is multi-layered in cross-section. The reinforcing member 10 includes a metal core 20, which is typically an iron-based alloy. Preferably, the metal core 20 is steel or tempered steel. In manufacture, the metal core 20 may contain a smooth surface, as shown. In the alternative, the surface may be patterned or textured to increase the bond strength between the reinforcing member 10 and the construction material, such as concrete. By way of example, such patterning on the surface of the metal core 20 may include ribs, threading or knurling. The metal core 20 may be 0.125 to 2 inches in diameter. The metal core may be formed as a singular unit or a combination of units affixed to each other.

The metal core 20 is coated with a galvanic layer 30, typically zinc, as is well known in the industry. Although multiple different methods of galvanizing steel are known and employed, the galvanic layer 30 is preferably applied to the metal core 20 during manufacture, permitting application of a thinner layer as compared to hot-dip galvanizing. Additionally, mill application eliminates the workplace and environmental hazards presented by hot-dip galvanization, as discussed previously. The galvanic layer 30 may be applied in any number of manners, such as, for example, electroplating.

Referring again to FIG. 2, surrounding the galvanic layer 30 is a barrier layer 40. The barrier layer 40 is composed of a chemically corrosive-resistant material and acts as an additional physical divider between the metal core 20 and the atmospheric conditions. To maximize the corrosive resistant effect of the barrier layer 40, the barrier layer 40 preferably completely covers and isolates the core 20 from elements needed for corrosion—oxygen, water and chloride ions. Corrosion resistance may decrease if any defects are present in the barrier layer 40, thereby exposing the galvanizing layer 30. Preferably, the barrier layer 40 is composed of an epoxy, such as a polyester epoxy, as is commonly used in the industry. In an embodiment, multiple barrier layers 40 may be applied successively, thereby increasing the total number of layers of the reinforcing member 10.

Accordingly, the corrosion resistance system of the present application provides both galvanic and mechanical protection of the metal core 20. The galvanic layer 30 is preferentially sacrificed when the reinforcing member 10 is in electrical contact, such as with an electrolyte. The present application overcomes the deficiencies of prior systems which have been unable to provide reinforcing member with a relatively long, maintenance-free life, and is easy to handle during field installation. By coating the galvanized steel with an epoxy layer, sharp dendrites forming during the galvanization process can be covered and protects the hands of the installers. Additionally, the epoxy layer eliminates stick of the reinforcing member during storage, as is common of simply galvanized products. The addition of a galvanic protectant layer beneath the epoxy layer provides greater leniency with regard to the overall integrity of the epoxy layer. As mentioned, the epoxy may become damaged or corrupted during storage or transportation, typically requiring repair and patching so that untreated steel will not be exposed to the elements and left susceptible to corrosion. In the present application, any defects in the epoxy layer will only expose the galvanized steel, which has a relatively high resistance to corrosion in and of itself. Finally, the use of mill applied galvanization is safer to manufacture and eliminates hazardous emissions during the manufacturing process.

In application, as shown in FIGS. 3 and 4, the reinforcing member 10 or network of reinforcing members 50 may be contained within a construction material 60, such as a concrete or cement structure or slab, in order to provide additional tensile strength to the structure. For example, masonry structures and the mortar holding them together have similar properties to concrete and also have a limited ability to carry tensile loads. Standard masonry units, like blocks and bricks, may contain manufactured holes to accommodate a reinforcing member 10, which is then secured in place with grout. Similarly, a mesh or lattice structure may be manufactured from multiple reinforcing members 10 that are welded together. Typically such configurations are used for reinforcing flat concrete elements, such as a footpath or patio slab. Once the reinforcing structure is in place in the form, the concrete or cement is then poured.

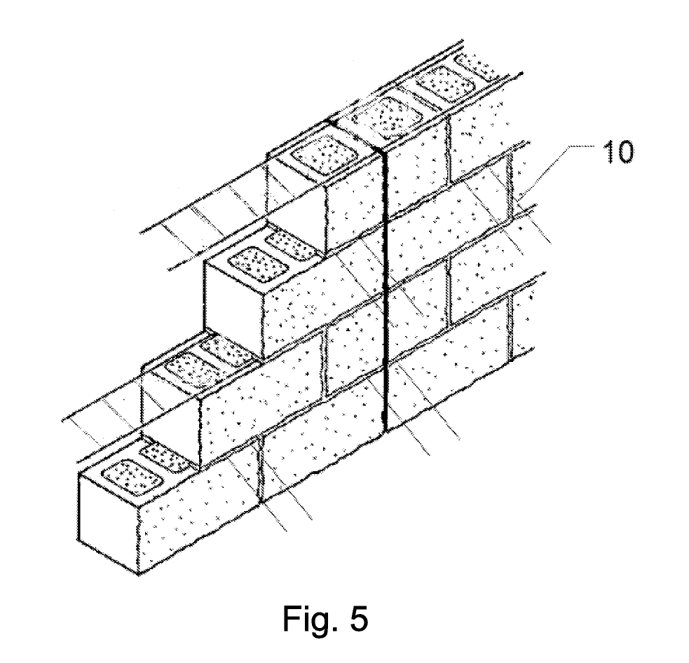

FIG. 5 shows another embodiment which shows the reinforcing members 10 placed in the joints of a block or concrete masonry unit (CMU). The reinforcing members 10 may or may not extend outwardly from the CMU.

Thus, while the invention has been described herein with relation to certain embodiments and applications, those with skill in this art will recognize changes, modifications, alterations and the like which still come within the spirit of the inventive concept, and such are intended to be included within the scope of the invention as expressed in the following claims.

1. A corrosion resistant structural reinforcing member for use in a construction material, the reinforcing member comprising:
a metal alloy core;
a galvanic protection layer coating the metal alloy core; and
at least one chemically corrosive-resistant barrier coating the galvanic protection layer, the galvanic protection layer being positioned between the metal alloy core and the chemically corrosive-resistant barrier.

2. The corrosion resistant structural reinforcing member of claim 1, wherein the metal alloy core is steel.

3. The corrosion resistant structural reinforcing member of claim 2, wherein the galvanic protection layer is zinc.

4. The corrosion resistant structural reinforcing member of claim 1, wherein the at least one chemically corrosive-resistant barrier coating is an epoxy.

5. The corrosion resistant structural reinforcing member of claim 1, wherein the reinforcing member comprises a wire or rod.

6. The corrosion resistant structural reinforcing member of claim 1, wherein the construction material is cement or concrete.

7. A method for resisting corrosion of structural reinforcing members for use in a construction material, the method comprising the steps of:
coating a metal alloy core of a reinforcing member with a galvanic protectant; and
applying an epoxy to the surface of the metal alloy core and galvanic protectant combination.

8. The method of claim 7 further comprising:
securing at least two reinforcing members together to create a mesh or lattice structure; and
adding construction material onto the mesh or lattice, thereby providing additional tensile strength to the mesh or lattice structure.

9. A structural member in the form of a composite layered structure embedded in a construction material, comprising:
a core containing a first metal;
a second metal applied to the core, the second metal being preferentially sacrificed when the structural member is in contact with an electrolyte; and
a chemically resistant coating applied to the second metal to isolate the core and second metal from the construction material.

10. The structural member of claim 9, wherein the first metal is steel.

11. The structural member of claim 10, wherein the second metal is zinc.

12. The structural member of claim 9, wherein the core is a singular unit or a combination of units affixed to each other.

13. The structural member of claim 9, wherein the core is 0.125 to 2 inches in diameter.
